(19) United States
(12) Patent Application Publication
(10) Pub. No.: US 2016/0091917 A1
(43) Pub. Date: Mar. 31, 2016

(54) CONSTANT CURRENT-CONSTANT VOLTAGE CIRCUIT

(71) Applicant: DENSO CORPORATION, Aichi (JP)

(72) Inventor: Takashi IMURA, Kariya-city (JP)

(73) Assignee: DENSO CORPORATION, Kariya-Aichi-pref (JP)

(21) Appl. No.: 14/891,743

(22) PCT Filed: Jun. 17, 2014
(86) PCT No.: PCT/JP2014/003225

§ 371 Date: Nov. 17, 2015

(30) Foreign Application Priority Data
Jul. 19, 2013 (JP) 2013-150556

(51) Int. Cl. G05F 3/26

(52) U.S. Cl. CPC G05F 3/262

(57) ABSTRACT

A constant current-constant voltage circuit includes a first resistor; a first transistor that is an N-channel type; a second transistor; a third transistor that is a P-channel type; a fourth transistor that is a P-channel type; a fifth transistor; a second resistor; and a first constant voltage element. The second resistor is coupled between the intermediate node and a source of the third transistor and the first constant voltage element is coupled between a source of the second transistor and the second power source line. A bias is set up and a source potential of the first transistor is equal to a source potential of the fifth transistor.

### CROSS REFERENCE TO RELATED APPLICATION

The application is based on Japanese Patent Application No. 2013-150556 filed on Jul. 19, 2013, the disclosure of which is incorporated herein by reference.

### TECHNICAL FIELD

This disclosure is related to a constant current-constant voltage circuit configured by a FET.

### BACKGROUND ART

In recent years, a hybrid vehicle and an electric vehicle that run by driving a motor by the power supplied from a battery have been put in practical use. In connection with the motorization of a vehicle, the necessity for a control circuit that receives and operates at a high voltage increases. When the control circuit is configured so as to directly operate with a high supply voltage, an element having a high withstand voltage is required. In order to manufacture a semiconductor device (IC) including a high withstand voltage element, it is necessary to prepare a manufacturing process different from a manufacturing process of a low withstand voltage element. Accordingly, the increase in cost is caused. It is common to adopt the configuration in which the high supply voltage is stepped down to a low voltage before supplying it to the control circuit, allowing the control circuit to operate at the low supply voltage. Various configurations are proposed as a constant current circuit/constant voltage circuit which is supplied with a high voltage and generates a desired constant current/constant voltage (refer to Patent literature 1, for example).

The inventor of the present invention has found the following regarding a constant current circuit/constant voltage circuit.

In order to configure the constant current circuit/constant voltage circuit at low cost, it may be necessary to configure the circuit with an element having a low withstand voltage compared with the supply voltage inputted. It may be also necessary to provide the constant current circuit/constant voltage circuit of a configuration with a high input stability, that is, a configuration with a small variation in the output current/output voltage against a variation of the supply voltage.

For example, a constant current circuit is known in which a series circuit of a fourth transistor, a first transistor, and a Zener diode, and a series circuit of a third transistor, a second transistor, and a resistor are coupled in parallel between the power source lines. In order to make it operate as a self-bias type, the fourth and the second transistors are saturation-connected, and gates of the third and the fourth transistors are coupled mutually and gates of the first and the second transistor are coupled mutually.

In this configuration, the difference of a drain-to-source voltage of the first and the second transistors as a pair, and the difference of a drain-to-source voltage of the third and the-fourth transistors as a pair increases as the supply voltage increases. It may be likely that the input stability is poor. Since a high voltage is applied to the first and the third transistors which are not saturation-connected, it is necessary to employ a transistor of a high withstand voltage. It may be also necessary to employ a transistor of a high withstand voltage as the second and the fourth transistors which make a pair with the first and the third transistors respectively, for the sake of the matching.

### PRIOR ART DOCUMENT

### Patent Document

Patent literature 1: JP 2001-142552 A

### SUMMARY OF THE INVENTION

It is an object of the present disclosure to provide a constant current-constant voltage circuit that is configured with an element with a withstand voltage lower than a supply voltage and that has a high input stability.

The constant current-constant voltage circuit according to one example of the present disclosure includes a first resistor that is coupled between an intermediate node and a first power source line, the intermediate node having an intermediate potential of the first power source line and a second power source line; a first transistor that is an N-channel type; a second transistor that is an N-channel type and is saturation-connected to the first transistor, in which a gate of the first transistor is coupled to a gate of the second transistor; a third transistor that is a P-channel type, in which a drain of the third transistor is coupled to a drain of the second transistor; a fourth transistor that is a P-channel type and is saturation-connected to the third transistor, in which a gate of the third transistor is coupled to a gate of the fourth transistor and a drain of the first transistor is coupled to a drain of the fourth transistor; a fifth transistor, in which a gate of the fifth transistor is coupled to the drain of the first transistor and the drain of the fourth transistor, and a drain of the fifth transistor is coupled to the intermediate node; a second resistor; and a first constant voltage element. The second resistor is coupled between the intermediate node and a source of the third transistor and the first constant voltage element is coupled between the intermediate node and a source of the fourth transistor; or the second resistor is coupled between a source of the second transistor and the second power source line, and the first constant voltage element coupled between a source of the first transistor and the second power source line. A bias is set up and a source potential of the first transistor is equal to a source potential of the fifth transistor. A constant current flows through the second transistor. A constant voltage is generated at the intermediate node.

According to the constant current-constant voltage circuit of the present disclosure, when the supply voltage applied between the first power source line and the second power source line increases, the voltage of the intermediate node and the gate potential of the third and the fourth transistors increase. In this case, the gate voltage of the fifth transistor rises, and the drain current of the fifth transistor increases. Accordingly, the current flowing through the first resistor increases and the voltage rise of the intermediate node is suppressed. By this feedback operation, a constant voltage is generated at the intermediate node. At this time, a voltage equal to the voltage of the first constant voltage element is applied to the second resistor. A constant current flows through the second transistor coupled in series with the second resistor.

By providing the fifth transistor, it may be possible to suppress the rise of the voltage at the intermediate node and the rise of the drain-to-source voltage of the first transistor which is not saturation-connected, due to the rise of the supply voltage. It may also be possible to suppress the rise of the drain-to-source voltage of the third transistor which is not saturation-connected. Therefore, a voltage higher than the constant voltage generated at the intermediate node is not applied to the first transistor through the fifth transistor which are coupled between the intermediate node and the second power source line, allowing the employment of a low withstand voltage element.

According to the configuration of the present disclosure, the drain-to-source voltages of the first transistor and the second transistor approach a close value within the range of the difference between the threshold voltage of the first transistor and the second transistor and the threshold voltage of the fifth transistor. The channel length modulation effect that occurs in the first transistor and the second transistor becomes almost equal. The channel length modulation effect that occurs in the third transistor and the fourth transistor also becomes almost equal. The accuracy of the current ratio of the current flowing through the first transistor and the fourth transistor and the current flowing through the second transistor and the third transistor increases, and it may be possible to generate a high-accuracy constant current and a high-accuracy constant voltage. The variation of the output current and the output voltage to the variation of the supply voltage becomes small, and the input stability may be enhanced.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating a constant current-constant voltage circuit according to a first embodiment of the present disclosure;

FIG. 2 is a diagram illustrating a change of voltage at each part to a change of a supply voltage;

FIG. 3 is a diagram illustrating a constant current-constant voltage circuit according to a second embodiment of the present disclosure;

FIG. 4 is a diagram illustrating a constant current-constant voltage circuit according to a third embodiment of the present disclosure; and

FIG. 5 is a diagram illustrating a constant current-constant voltage circuit according to a fourth embodiment of the present disclosure.

### PREFERRED EMBODIMENTS FOR CARRYING OUT THE INVENTION

In the following embodiments, the same symbol or reference numeral is attached to the substantially same element, and the repeated explanation will be omitted.

### First Embodiment

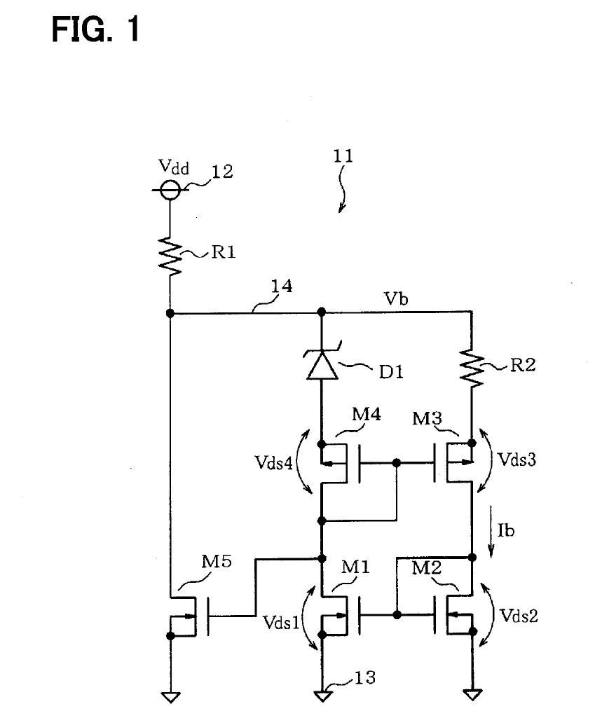

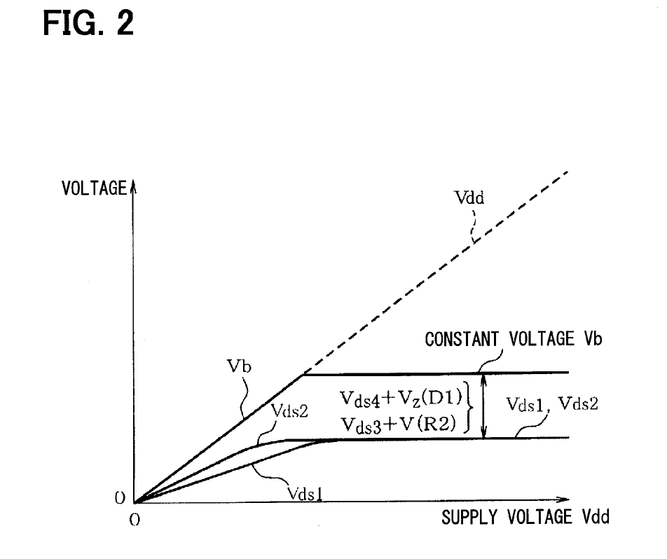

With reference to FIG. 1 and FIG. 2, a first embodiment of the present disclosure will be explained. A constant current-constant voltage circuit 11 illustrated in FIG. 1 is used for an electronic control apparatus mounted to a hybrid vehicle or an electric vehicle that run by driving a motor by the power supplied from a power drive battery. Between a first power source line 12 and a second power source line 13 (a ground line), a supply voltage Vdd of about 200V to 300V is applied from the battery.

The constant current-constant voltage circuit 11 generates a constant voltage Vb at an intermediate node 14 having an intermediate potential of the first power source line 12 and the second power source line 13, and flows a constant drain current Ib (also referred to as a constant current Ib) through a second transistor M2. A first resistor R1 is coupled between the first power source line 12 and the intermediate node 14. Between the intermediate node 14 and the second power source line 13, a first transistor M1, a second transistor M2, a third transistor M3, a fourth transistor M4, a fifth transistor M5, a second resistor R2, and a Zener diode D1 are coupled. The transistors M1, M2, and M5 are N-channel MOSFETs (metal-oxide-semiconductor field-effect transistors) having the mutually equal threshold voltage and the same size. The transistors M3 and M4 are P-channel MOSFETs having the mutually equal threshold voltage and the same size.

The first transistor M1 and the second transistor M2, which is in a saturation connection with the first transistor M1, have the sources grounded to the second power source line 13, and the gates are coupled mutually to provide a pair. Incidentally, the saturation connection is a kind of wiring to connect a gate to a drain so that the transistor operates in a saturation region. The third transistor M3 and the fourth transistor M4, which is saturation-connected to the third transistor M3, also form a pair with the gates coupled mutually. The drains of the transistors M1 and M4 are coupled mutually, and the drains of the transistors M2 and M3 are coupled mutually.

The second resistor R2 is coupled between the intermediate node 14 and a source of the third transistor M3. The Zener diode D1 is coupled between the intermediate node 14 and a source of the fourth transistor M4, with the cathode disposed on a side of the intermediate node 14. The Zener diode D1 corresponds to a first constant voltage element of the present disclosure.

A gate of the fifth transistor M5 is coupled to the drains of the transistors M1 and M4, and a drain thereof is coupled to the intermediate node 14. A source of the fifth transistor M5 is coupled to the second power source line 13. The bias setup is performed so that the source potential of the first transistor M1 and the source potential of the fifth transistor M5 are both set at the ground potential. The constant current Ib which flows through the second transistor M2 is pulled out via a transistor (not shown) that provides a current mirror circuit in combination with the second transistor M2.

With reference to FIG. 1 and FIG. 2, the operation and effect of the present embodiment will be explained. When the currents flowing through the Zener diode D1 and the second resistor R2 are equal, the gate-to-source voltages (gate voltages) of the transistors M3 and M4 become equal. Since the gates of the transistors M3 and M4 are coupled mutually, the voltage of the Zener diode D1 and the voltage of the second resistor R2 become equal and constant, irrespective of the supply voltage Vdd. Therefore, when the supply voltage Vdd rises, for example, the voltage at the intermediate node 14 and the gate potential of the transistors M3 and M4 tend to rise.

Accordingly, the gate voltage of the fifth transistor M5 rises, and the drain current of the fifth transistor M5 increases. The current flowing through the first resistor R1 increases, and the voltage rise at intermediate node 14 is suppressed. By this feedback operation, a constant voltage Vb expressed by Equation (1) is generated at the intermediate node 14. In Equation (1), Vgs (M4) is a gate voltage of the fourth transistor M4, Vgs (M5) is a gate voltage of the fifth transistor M5, Vz (D1) is a Zener voltage of the Zener diode D1, Vds (M1) is a drain-to-source voltage of the first transistor M1, and Vds (M4) is a drain-to-source voltage of the fourth transistor M4.

$$\begin{matrix}Vb = Vgs ( M 5 ) + Vgs ( M 4 ) + Vz ( D 1 ) \\ = Vds ( M 1 ) + Vds ( M 4 ) + Vz ( D 1 )\end{matrix} \qquad Equation ( 1 )$$

A voltage equal to the Zener voltage Vz (D1) is applied to the second resistor R2. A constant current Ib expressed by Equation (2) flows through the series circuit of the second resistor R2 and the transistors M3 and M2.

Ib=Vz(D1)/R2 Equation (2)

By providing the fifth transistor M5, even when the supply voltage

Vdd rises, it may be possible to suppress the rise of the voltage at the intermediate node 14 and the rise of the drain-to-source voltage Vds1 of the first transistor M1. Accordingly, it may also be possible to suppress the rise of the drain-to-source voltage Vds3 of the third transistor M3. Therefore, a voltage higher than the constant voltage Vb (For example, 12V) is not applied to the transistors M1-M5 coupled between the intermediate node 14 and the second power source line 13. It may be possible to employ a low withstand voltage element, for example, an element having the withstand voltage of 40V, as the transistors M1-M5.

An amplification factor of the fifth transistor M5 is finite. Accordingly, the gate voltage of the fifth transistor M5 varies when the supply voltage Vdd varies. Accordingly, in the present embodiment, the transistors M1, M2, and M5 are configured so as to have an equal threshold voltage mutually. Accordingly, the gate voltage of the transistors M1, M2, and M5 becomes a value close to the threshold voltage. When a MOSFET is operated at the gate voltage near the threshold voltage, a high amplification factor is obtained. The amplification factor of the fifth transistor M5 becomes high, and the variation of the gate voltage of the fifth transistor M5 due to the variation of the supply voltage Vdd becomes small.

The drain-to-source voltage Vds1 of the transistor M1 and the drain-to-source voltage Vds2 of the transistor M2 become equal. Accordingly, the channel length modulation effects occurring in the transistors M1 and M2 become equal. Similarly, the drain-to-source voltage Vds3 of the transistor M3 and the drain-to-source voltage Vds4 of the transistor M4 also become equal. Accordingly, the channel length modulation effects occurring in the transistors M3 and M4 becomes equal. Accordingly, the accuracy of the current ratio (also referred to as a mirror ratio) of the current flowing through the transistors M1 and M4 and the current flowing through the transistors M2 and M3 increases. Accordingly, it may be possible to generate the constant current Ib in high accuracy and the constant voltage Vb in high accuracy. The variation of the constant current Ib and the constant voltage Vb to the variation of the supply voltage Vdd becomes small, and a high input stability is obtained.

FIG. 2 illustrates the voltage change of each part to the change of the supply voltage Vdd. When the supply voltage Vdd is greater than the voltage value defined by Equation (1), the constant voltage Vb described above becomes constant. The drain-to-source voltages Vds1 and Vds2 of the transistors M1 and M2, the drain-to-source voltages Vds3 and Vds4 of the transistors M3 and M4, and the Zener voltage Vz (D1) and the voltage V (R2) of the second resistor R2 become equal, respectively. When the supply voltage Vdd becomes smaller than the voltage value defined by Equation (1), the fifth transistor M5 turns off. Therefore, the feedback operation disappears.

As explained above, the constant current-constant voltage circuit 11 according to the present embodiment is configured with the transistors M1-M5 with the withstand voltage lower than the supply voltage Vdd. Therefore, it may be possible to reduce the layout area of the semiconductor device and to reduce the production cost. It may be possible that the constant current-constant voltage circuit 11 is excellent in the input stability, and it may be possible to generate the constant current Ib in high-accuracy and the constant voltage Vb in high-accuracy.

### Second Embodiment

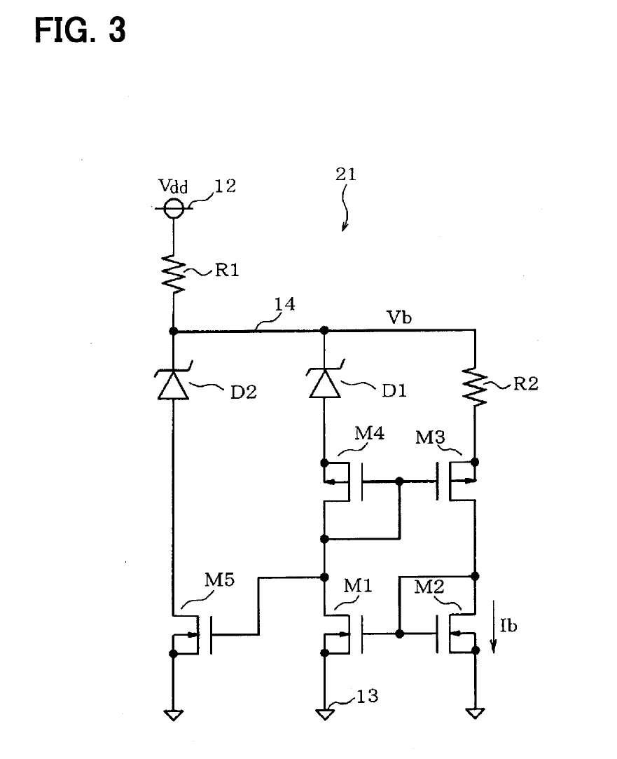

A second embodiment is explained with reference to FIG. 3. A constant current-constant voltage circuit 21 is different from the constant current-constant voltage circuit 11 illustrated in FIG. 1 in that a Zener diode D2 is included between the intermediate node 14 and the drain of the fifth transistor M5. Other configuration is the same. The Zener diode D2 corresponds to a second constant voltage element according to the present disclosure. In the constant current-constant voltage circuit 11, the highest constant voltage Vb is applied to the fifth transistor M5 among the transistors M1-M5. According to the present embodiment, the drain-to-source voltage of the fifth transistor M5 decreases by the Zener voltage Vz (D2) of the Zener diode D2. Therefore, it may be possible to further reduce the element withstand voltage of the fifth transistor M5. In addition, it may be possible to obtain the same operation and effect as those in the first embodiment.

### Third Embodiment

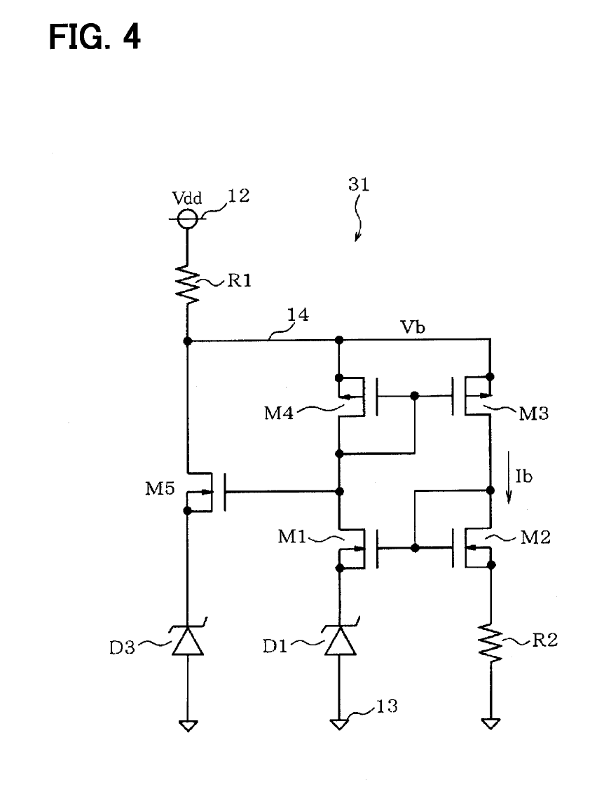

A third embodiment is explained with reference to FIG. 4. Instead of including the second resistor R2 and the Zener diode D1 between the intermediate node 14 and the transistors M3 and M4, a constant current-constant voltage circuit 31 includes the second resistor R2 and the Zener diode D1 between the sources of the transistors M2 and M1, and the second power source line 13. Furthermore, in order to equalize the source potential of the first transistor M1 and the source potential of the fifth transistor M5, a Zener diode D3 is coupled between the source of the fifth transistor M5 and the second power source line 13. Other configurations are the same as the constant current-constant voltage circuit 11 illustrated in FIG. 1. The Zener diode D3 corresponds to the third constant voltage element according to the present disclosure.

Since the threshold voltages of the transistors M1, M2, and M5 are mutually equal, it is only necessary to set the Zener voltages of the Zener diodes D1 and D3 to be equal. In this way, it may be possible to obtain the same operation and effect as those in the first embodiment by the present embodiment in which the bias setup is performed so as to equalize the source potential of the first transistor M1 and the source potential of the fifth transistor M5.

### Fourth Embodiment

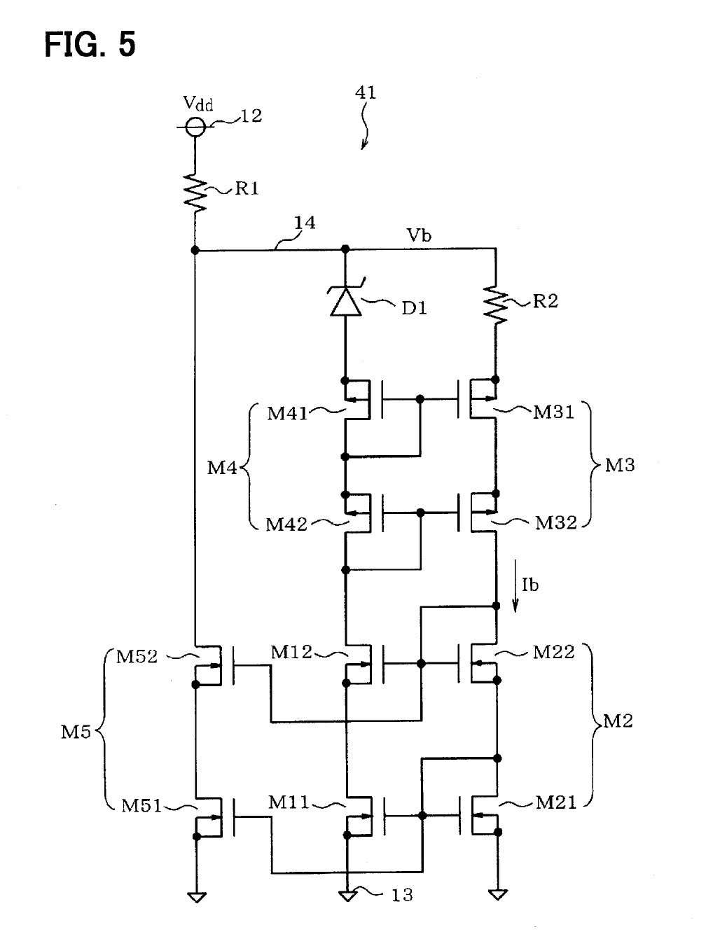

A fourth embodiment is explained with reference to FIG. 5. A constant current-constant voltage circuit 41 is configured with cascode connections in place of the transistors M1-M5 of the constant current-constant voltage circuit 11 illustrated in FIG. 1. For example, the first transistor M1 is replaced with saturation-connected transistors M11 and M12. The second transistor M2 is replaced with saturation-connected transistors M21 and M22. The third transistor M3 is replaced with saturation-connected transistors M31 and M32. The fourth transistor M4 is replaced with saturation-connected transistors M41 and M42. The fifth transistor M5 is replaced with saturation-connected transistors M51 and M52. In this case, in order to obtain the high-accuracy constant current Ib and constant voltage Vb, it is only necessary to set the threshold voltages of the transistors M11, M21, and M51 to be equal mutually, and to set the threshold voltages of the transistors M31 and M41 to be equal mutually. Other configurations are the same as in the constant current-constant voltage circuit 11.

According to this configuration, variations of the drain-to-source voltages of the transistors M11 and M21 placed nearer the second power source line 13 among the transistors M1 and M2 become small. The influence of the channel length modulation effect becomes small, leading to further enhancement of the input stability. Similarly, variations of the drain-to-source voltages of the transistors M31 and M41 placed nearer the intermediate node 14 among the transistors M3 and M4 become small. The influence of the channel length modulation effect becomes small, leading to further enhancement of the input stability. Other operation and effect are the same as those of the first embodiment.

### Other Embodiments

As described above, the preferred embodiments of the present disclosure have been explained. However, the present disclosure is not restricted to the embodiments as described above, and various modifications and extensions are possible in the range which does not deviate from the gist of the disclosure.

In each embodiment, the size of the transistors M1-M5 may be different. Assuming that the ratios of the channel width to the channel length of the transistors M1-M4 are expressed as W/L1-W/L4, and when the relation of W/L1:W/L2=W/L4:W/L3 holds, it may be possible to generate the high-accuracy constant current Ib and constant voltage Vb which are excellent particularly in the input stability.

Even when the threshold voltages of the transistors M1, M2, and M5 are mutually different and the threshold voltages of the transistors M3 and M4 are mutually different, it may be possible to generate the constant current Ib and the constant voltage Vb which are excellent in the input stability. It may be possible to configure the constant current-constant voltage circuit by employing the transistors M1-M5 with the withstand voltage smaller than the supply voltage Vdd.

Also in the second and third embodiments, the transistors M1-M5 may be changed to the form of cascode connection respectively. In each embodiment and modified example, only the transistors M1, M2, and M5 among the transistors M1-M5 may be changed to the form of cascode connection or only the transistors M3 and M4 may be changed to the form of cascode connection. The number of stages of the cascode connection is not restricted to 2.

In the third and fourth embodiments, when the Zener diode D2 is coupled between the intermediate node 14 and the drain of the fifth transistor M5, it may be possible to reduce the element withstand voltage of the fifth transistor M5.

An application of the constant current-constant voltage circuits 11, 21, 31, and 41 and their modification circuits is not restricted to the electronic control apparatus of a vehicle. They may be used in a wide area using the constant current constant voltage.

The constant current-constant voltage circuits 11, 21, 31, and 41 according to an example of the present disclosure include: the first resistor R1 coupled between the intermediate node 14 and the first power source line 12, the intermediate node 14 having an intermediate potential of the first power source line 12 and the second power source line 13; the first transistor M1 which is an N-channel type; the second transistor M2 which is a N-channel type saturation-connected to the first transistor M1; the third transistor M3 which is a P-channel type; the fourth transistor M4 which is a P-channel type saturation-connected to the third transistor M3; the fifth transistor M5; the second resistor R2 coupled between the intermediate node 14 and the source of the third transistor M3; and the first constant voltage element D1 coupled between the intermediate node 14 and the source of the fourth transistor M4. Alternatively, instead of the second resistor R2 coupled between the intermediate node 14 and the source of the third transistor M3 and the first constant voltage element D1 coupled between the intermediate node 14 and the source of the fourth transistor M4, the constant current-constant voltage circuits 11, 21, 31, and 41 include: the second resistor R2 coupled between the source of the second transistor M2 and the second power source line 13; and the first constant voltage element D1 coupled between the source of the first transistor M1 and the second power source line 13. The gate of the first transistor M1 and the gate of the second transistor M2 are coupled. The drain of the second transistor M2 and the drain of the third transistor M3 are coupled. The gate of the third transistor M3 and the gate of the fourth transistor M4 are coupled, and the drain of the first transistor M1 and the drain of the fourth transistor M4 are coupled. The gate of the fifth transistor M5 is coupled to the drain of the first transistor M1 and to the drain of the fourth transistor M4, and the drain of the fifth transistor M5 is coupled to the intermediate node 14. In the constant current-constant voltage circuits 11, 21, 31, and 41, a bias is set up so as to make the source potential of the first transistor M1 equal to the source potential of the fifth transistor M5, to flow a constant current through the second transistor M2, and to generate a constant voltage at the intermediate node 14.

The constant current-constant voltage circuit according to one example of the present disclosure generates a constant voltage at the intermediate node having an intermediate potential of the first power source line and the second power source line, and the constant current-constant voltage circuit flows a constant current through the second transistor. The first resistor R1 is coupled between the first power source line and the intermediate node. The first transistor through the fifth transistor, the second resistor, and the first constant voltage element are coupled between the intermediate node and the second power source line. The first transistor, the second transistor, and the fifth transistor are N-channel FETs. The third transistor and the fourth transistor are P-channel FETs.

The first transistor and the saturation-connected second transistor form a pair by coupling their gates mutually. The third transistor and the saturation-connected fourth transistor also form a pair by coupling their gates mutually. The drains of the first transistor and the fourth transistor are coupled, and the drains of the second transistor and the third transistor are coupled. The gate of the fifth transistor is coupled to the drains of the first transistor and the fourth transistor, and the drain of the fifth transistor is coupled to the intermediate node.

The second resistor is coupled between the intermediate node and the source of the third transistor and the first constant voltage element is coupled between the intermediate node and the source of the fourth transistor, or the second resistor is coupled between the source of the second transistor and the second power source line and the first constant voltage element is coupled between the source of the first transistor and the second power source line. Furthermore, the bias setup is performed so that the source potential of the first transistor and the source potential of the fifth transistor become equal.

In this configuration, when the supply voltage applied between the first power source line and the second power source line rises, the voltage at the intermediate node and the gate potential of the third transistor and the fourth transistor rise. In this case, the gate voltage of the fifth transistor rises, and the drain current of the fifth transistor increases. Accordingly, the current flowing through the first resistor increases and the voltage rise of the intermediate node is suppressed. By this feedback operation, a constant voltage is generated at the intermediate node. A voltage equal to the voltage of the first constant voltage element is applied to the second resistor. Therefore, a constant current flows through the second transistor, which is coupled in series with the second resistor.

By providing the fifth transistor in this way, when the supply voltage rises, it may be possible to suppress the voltage rise of the intermediate node and the voltage rise between the drain and the source of the first transistor which is not saturation-connected. It may also be possible to suppress the rise of the drain-to-source voltage of the third transistor which is not saturation-connected. Therefore, a voltage higher than the constant voltage generated at the intermediate node is not applied to the first transistor through the fifth transistor, which are coupled between the intermediate node and the second power source line, and it may be possible to use a low withstand voltage element.

According to the configuration of the present disclosure, the drain-to-source voltages of the first transistor and the second transistor approach a close value within the range of the difference between the threshold voltage of the first transistor and the second transistor, and the threshold voltage of the fifth transistor. Therefore, the channel length modulation effect which occurs in the first transistor and the second transistor becomes almost equal. The channel length modulation effect which occurs in the third transistor and the fourth transistor also becomes almost equal. The accuracy of the current ratio of the current flowing through the first transistor and the fourth transistor and the current flowing through the second transistor and the third transistor increases. It may be possible to generate a high-accuracy constant current and a high-accuracy constant voltage. It may be possible to reduce the variation of the output current and the output voltage to the variation of the supply voltage and to enhance the input stability.

According to another example of the present disclosure, the threshold voltages of the first transistor, the second transistor, and the fifth transistor are mutually equal. The amplification factor of the fifth transistor is finite. Accordingly, the gate voltage of the fifth transistor varies slightly when the supply voltage Vdd varies. When an FET is operated at the gate voltage near the threshold voltage, a high amplification factor is obtained. The gate voltages of the first transistor and the second transistor are set as a value near the threshold voltage.

According to this configuration, the gate voltage of the fifth transistor is also set as a value near the threshold voltage. Accordingly, the amplification factor of the fifth transistor becomes high, and the variation of the gate-to-source voltage of the fifth transistor due to the variation of the supply voltage becomes small. The drain-to-source voltages of the first transistor and the second transistor and the drain-to-source voltages of the third transistor and the fourth transistor become equal, respectively. Therefore, it may be possible to further enhance the input stability.

According to another example of the present disclosure, the first transistor, the second transistor, and the fifth transistor may include the form of cascode connection, respectively. According to the present configuration, variations of the drain-to-source voltage of a transistor placed on the side of the second power source line become small, among the transistors included in the first transistor and the second transistor in the form of cascode connection. The influence of the channel length modulation effect becomes small, and it may be possible to further enhance the input stability.

According to another example of the present disclosure, the third transistor and the fourth transistor include the form of cascode connection, respectively. According to the present configuration, a transistor placed on the intermediate node side among the transistors in the cascode connection which compose the third and the fourth transistor has a small variation of the drain-to-source voltage. The influence of the channel length modulation effect becomes small, and it may be possible to further enhance the input stability.

According to another example of the present disclosure, the second constant voltage element is provided between the intermediate node and the drain of the fifth transistor. Accordingly, the drain-to-source voltage of the fifth transistor decreases. It may be possible to further reduce the withstand voltage of the fifth transistor.

According to further another example of the present disclosure, when the second resistor is coupled between the source of the second transistor and the second power source line, and when the first constant voltage element is coupled between the source of the first transistor and the second power source line, the third constant voltage element is arranged between the source of the fifth transistor and the second power source line, so as to equalize the source potential of the first transistor and the source potential of the fifth transistor. When the threshold voltages of the first transistor, the second transistor, and the fifth transistor are mutually equal, it is only necessary to set the voltage of the first constant voltage element and the voltage of the third constant voltage element to be equal.

The embodiments, the configuration, and the aspect of the constant current-constant voltage circuit according to the present disclosure have been illustrated in the above. However, the embodiment, the configuration, and the aspect according to the present disclosure are not restricted to each embodiment, each configuration, and each aspect which have been described above. For example, the embodiment, configuration, and aspect which are obtained by combining suitably the technical part disclosed in different embodiments, configurations, and aspects are also included in the range of the embodiments, configurations, and aspects according to the present disclosure.

1. A constant current-constant voltage circuit comprising:
a first resistor that is coupled between an intermediate node and a first power source line, the intermediate node having an intermediate potential of the first power source line and a second power source line;
a first transistor that is an N-channel type;
a second transistor that is an N-channel type and is saturation-connected to the first transistor, wherein a gate of the first transistor is coupled to a gate of the second transistor;
a third transistor that is a P-channel type, wherein a drain of the third transistor is coupled to a drain of the second transistor;
a fourth transistor that is a P-channel type and is saturation-connected to the third transistor wherein a gate of the third transistor is coupled to a gate of the fourth transistor and a drain of the first transistor is coupled to a drain of the fourth transistor;
a fifth transistor, wherein a gate of the fifth transistor is coupled to the drain of the first transistor and the drain of the fourth transistor, and a drain of the fifth transistor is coupled to the intermediate node;
a second resistor; and
a first constant voltage element,
wherein:
the second resistor is coupled between the intermediate node and a source of the third transistor and the first constant voltage element is coupled between the intermediate node and a source of the fourth transistor, or
the second resistor is coupled between a source of the second transistor and the second power source line and the first constant voltage element is coupled between a source of the first transistor and the second power source line;
a source potential of the first transistor is equal to a source potential of the fifth transistor by setting up a bias;
a constant current flows through the second transistor; and
a constant voltage is generated at the intermediate node.

2. The constant current-constant voltage circuit according to claim 1, wherein:
threshold voltages of the first transistor, the second transistor, and the fifth transistor are mutually equal.

3. The constant current-constant voltage circuit according to claim 1, wherein:
each of the first transistor, the second transistor, and the fifth transistor has a cascode connection.

4. The constant current-constant voltage circuit according to claim 1, wherein:
each of the third transistor and the fourth transistor has a cascode connection.

5. The constant current-constant voltage circuit according to claim 1, further comprising:
a second constant voltage element that is provided between the intermediate node and the drain of the fifth transistor.

6. The constant current-constant voltage circuit according to claim 1, further comprising:
a third constant voltage element that is provided between a source of the fifth transistor and the second power source line, when the second resistor is coupled between the source of the second transistor and the second power source line and the first constant voltage element is coupled between the source of the first transistor and the second power source line,
wherein:
the source potential of the first transistor is equal to the source potential of the fifth transistor.
